(19) United States
(12) Patent Application Publication
(10) Pub. No.: US 2018/0317677 A1
(43) Pub. Date: Nov. 8, 2018

(54) PILLOW

(71) Applicant: Nattalia Genao, Flushing, NY (US)

(72) Inventor: Nattalia Genao, Flushing, NY (US)

(21) Appl. No.: 15/972,206

(22) Filed: May 6, 2018

Related U.S. Application Data
(60) Provisional application No. 62/501,735, filed on May 4, 2017.

(51) Int. Cl. A47G 9/10; H04R 5/02

(52) U.S. Cl. CPC A47G 9/1045; A47G 2009/1018; H04R 5/023; A47G 9/1036

(57) ABSTRACT

An improved pillow structured and arranged to play music, including the comfort of memory foam, and the cooling capabilities of cooling gel while having an integrated fan.

### CROSS-REFERENCE TO RELATED APPLICATION

The present application is related to and claims priority from prior provisional application Ser. No. 62/502,735, filed May 7, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of pillow devices and more specifically relates to an improved pillow structured and arranged to play music, including the comfort of memory foam, and the cooling capabilities of cooling gel while having an integrated fan.

### 2. Description of the Related Art

Uninterrupted sleep is essential for people to enjoy a productive and happy life. Well rested, an individual is ready to face the challenges of the day ahead. However, this simple goal can be impeded when the person is afflicted with temporary or recurring ailments or maladies that lead to discomfort and restlessness. Internal conditions, such as sleep apnea, acid reflux, and hot flashes from menopause, keep many Americans tossing and turning throughout the night. In addition, muscle ailments such as arthritis or bone injuries can also result in many hours of lost sleep. The common thread that these afflictions share, in addition to the discomfort they cause, is that for each, doctors recommend elevation of the head or injured or sore body part to help alleviate symptoms. Also conducive to achieving relief for migraines and even simple restlessness is the use of cold and sound therapy, respectively.

Various attempts have been made to solve problems found in pillows with speakers art. Among these are found in: U.S. Pat. No. 9,003,582 to Robert Scott Armbruster; U.S. Pat. No. 8,325,934 to Sen M. Kuo; and U.S. Pat. No. 5,313,678 to Frances H. Redewill. This prior art is representative of pillows equipped with speakers for listening to music and other soothing sounds.

Ideally, an improved pillow should be user-friendly and safe in-use and yet would operate reliably and be manufactured at a modest expense. Thus, a need exists for an improved pillow structured and arranged to play music, including the comfort of memory foam, and the cooling capabilities of cooling gel while having an integrated fan and to avoid the above-mentioned problems.

### BRIEF SUMMARY OF THE INVENTION

In view of the foregoing disadvantages inherent in the known of pillow device art, the present invention provides a novel Improved Pillow Device. The general purpose of the present invention, which will be described subsequently in greater detail is to provide an improved pillow structured and arranged to play music, including the comfort of memory foam, and the cooling capabilities of cooling gel while having an integrated fan.

An improved pillow comprising: a main body including: a top surface, at least one side surface, a bottom surface, and a foam material; a fan member; at least one speaker member; and a power source. Wherein the top surface includes a semi-circular portion in a center section thereof having at least one side wall and a head supporting wall forming a semi-circular indentation therein; and wherein the semi-circular indentation is sized and adapted to have a person's head fit therein. Wherein the at least one side wall includes a first opening therethrough. Wherein the at least one side surface includes a second opening therethrough. Wherein the top surface, the at least one side surface, and the bottom surface form an exterior surface and an interior volume

Wherein the foam material is located within the interior volume and is adapted to provide support to the top surface, the at least one side surface, and the bottom surface, and thereby adapted to support a person's head upon the semi-circular indentation.

Wherein the fan member is located within said interior volume of the main body and adapted to draw air into the interior volume through the first opening and push air outwardly from the interior volume through the second opening. Wherein the at least one speaker member is located within the interior volume of the main body and adjacent said at least one side wall of the semi-circular portion and adapted to send audio sounds into the semi-circular indentation, such that a person can hear the audio sounds when using the improved pillow. Wherein the power source is electrically connected to the fan member and the at least one speaker member and adapted to provide electric power thereto.

The present invention holds significant improvements and serves as an Improved Pillow. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, an Improved Pillow, constructed and operative according to the teachings of the present invention.

FIG. 1 shows a perspective view illustrating an Improved Pillow according to an embodiment of the present invention.

FIG. 2 is a perspective view illustrating a USB port, BLUETOOTH Technology, and on/off switch according to an embodiment of the present invention of FIG. 1.

FIG. 3 is a perspective view illustrating a pillow cover of the improved pillow according to an embodiment of the present invention of FIG. 1.

FIG. 4 is a perspective view illustrating an improved pillow in an in-use condition according to an embodiment of the present invention of FIG. 1.

The various embodiments of the present invention will hereinafter be described in conjunction with the appended drawings, wherein like designations denote like elements.

### DETAILED DESCRIPTION

As discussed above, embodiments of the present invention relate to a pillow device and more particularly to an improved pillow structured and arranged to play music, including the comfort of memory foam, and the cooling capabilities of cooling gel while having an integrated fan.

Generally speaking, the improved pillow comprises a specially designed multipurpose aid in the quest for relief from a variety of ailments, such as those described above, that can hinder rest. Simply stated, the Improved Pillow is a specially designed, ergonomic pillow that is also equipped with both cooling and heating capabilities.

Largely constructed of a durable yet cushiony memory foam material, this product would basically be rectangular in shape. The center of the pillow would boast a semi-circular cutout, which would serve to accommodate the head in sheathing, cool comfort. Ensconced within separate chambers, the interior components of this product would be comprised of a battery-operated fan positioned above where the head would rest, cooling gel, and a zipper section, located around the perimeter of the headrest. Further attributing to the uniqueness of the Improved Pillow would be two (2) internal speakers, located inside the headrest where each ear would be positioned. These speakers would activate via Bluetooth® technology and a rechargeable battery source, and would be able to sync with a music player such as one's smartphone or tablet computer.

A simple ON/OFF switch will also be included, along with a USB port for use with a smartphone, tablet or computer which may not have Bluetooth® capabilities. With its many applications, this versatile product could be used in a plethora of ways to ensure comfort. As mentioned, a fitted pillow case will be sold separately. This case will fit the Improved Pillow like a glove, and would feature a zipper closure just below the rear fan vent. It would also have a lined opening for the fan front, and rear, of the pillow case. Cut-outs will also be strategically placed to accommodate the controls of the unit as well as its adjustable cord. This case will serve to show off the features of the Improved Pillow, yet keep it comfortable, clean, and pristine.

The Improved Pillow is an innovative product invention that would help millions of Americans find comfort and relief from common ailments, so that they can enjoy a good night's sleep. The Improved Pillow would provide consumers with a device that offers relief from a variety of common ailments, all in one convenient unit. Unique components, the handy fan and cooling gel would allow those suffering from fevers or hot flashes to rest their heads on a blissfully cool pillow, alleviating their discomfort and facilitating rest. This is also useful for those who prefer the “cool side of the pillow.”

Moreover, the creative addition of Bluetooth® speakers would allow users to lull themselves to slumber with calming music. Eliminating the need to use earphones or earbuds for this purpose, the Improved Pillow would not result in sore ears, but rather, extreme comfort. While the Improved Pillow was primarily conceived with household users in mind, this therapeutic device would be ideal for use in day spas, hospitals, and nursing homes, as well.

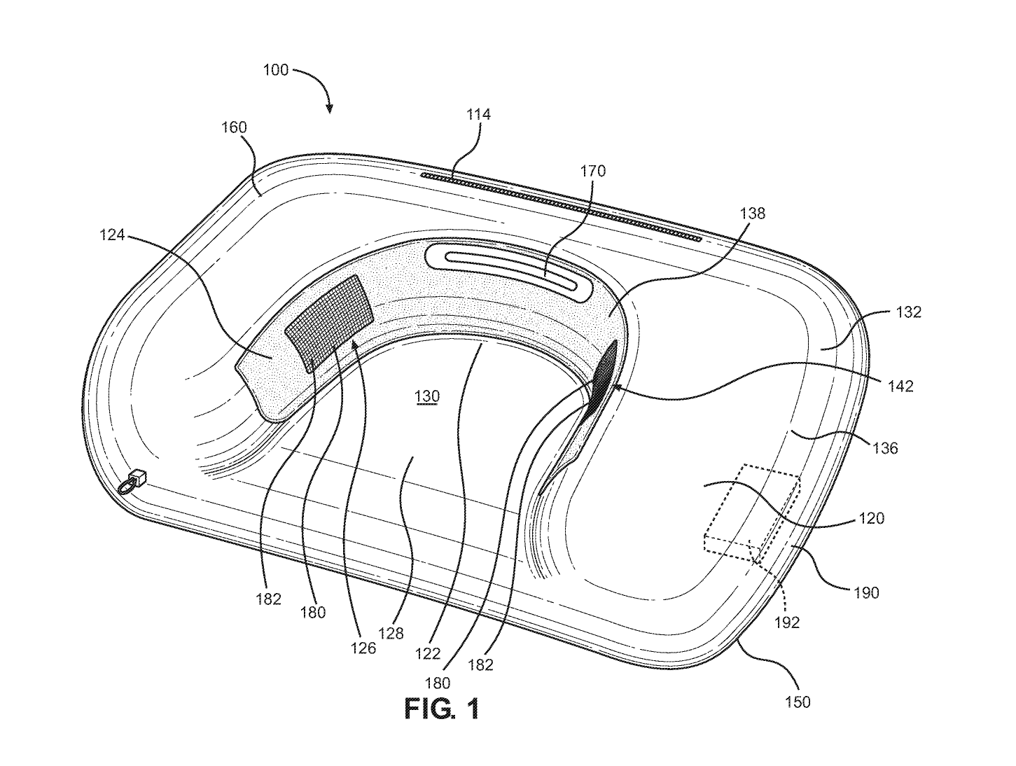

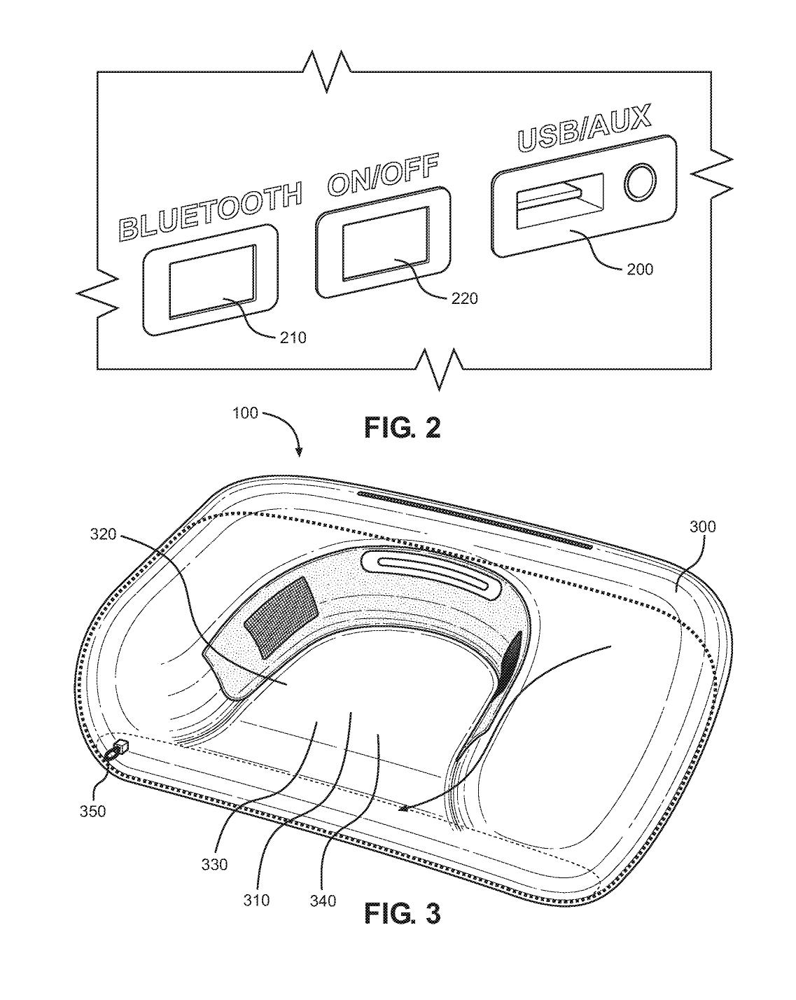

Referring to the drawings by numerals of reference there is shown in FIGS. 1-3, perspective views illustrating improved pillow 100 according to an embodiment of the present invention.

Improved pillow 100 comprising: main body 110 including: top surface 120, at least one side surface 140, bottom surface 150, and foam material 160; fan member 170; at least one speaker member 180; and power source 190. Wherein top surface 120 includes semi-circular portion 122 in a center section thereof having at least one side wall 124 and head supporting wall 128 forming semi-circular indentation 130 therein; and wherein semi-circular indentation 130 is sized and adapted to have a person's head fit therein. Wherein at least one side wall 124 includes first opening 126 therethrough. Wherein at least one side surface 140 includes second opening 142 therethrough. Wherein top surface 120, at least one side surface 140, and bottom surface 150 form exterior surface 132 and interior volume 136. Improved pillow 100 further comprising cooling gel 138 located within interior volume 136 of main body 110 and adjacent at least one side wall 124 and head supporting wall 128 of semi-circular portion 122 of top surface 120 of main body 110. Wherein main body 110 further includes zipper member 114 thereon adapted to allow access therethrough and into interior volume 136

Wherein foam material 160 is located within interior volume 136 and is adapted to provide support to top surface 120 at least one side surface 140, and bottom surface 150, and thereby adapted to support a person's head upon semi-circular indentation 130. Wherein foam material 160 is formed from memory foam material.

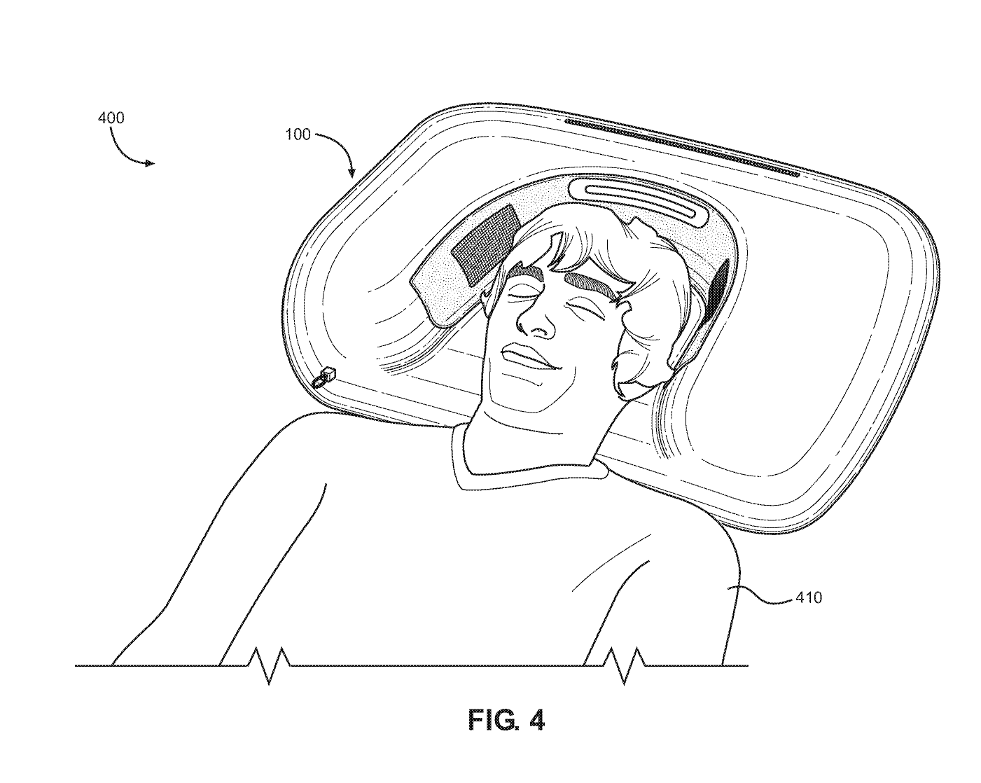

Improved pillow 100 further comprising pillow cover 300 adapted to surround main body 110 as shown in FIG. 3. Wherein pillow cover 300 includes semi-circular portion 310 in a center section thereof including at least one side portion 320 and head supporting portion 330 adapted to form semi-circular indentation 340 substantially similar to semi-circular portion 122 of top portion 120 of main body 110; and wherein pillow cover 300 is adapted to contact a substantial portion of exterior surface 132 of main body 110. Wherein pillow cover 300 further includes adjustment cord 350 adapted to allow pillow cover 300 to be tightened and loosened around exterior surface 132 of main body 110. Wherein adjustment cord 350 is formed as a draw-string. Wherein pillow cover 300 is formed from a material chosen from a list of materials consisting of cotton, nylon, and silk.

Wherein said fan member 170 is located within said interior volume of said main body and adapted to draw air into said interior volume through said first opening and push air outwardly from said interior volume through said second opening.

Wherein at least one speaker member 180 is located within interior volume 136 of main body 110 and adjacent at least one side wall 124 of semi-circular portion 122 and adapted to send audio sounds into semi-circular indentation 130, such that person 410 can hear the audio sounds when using improved pillow 100 as shown in in-use condition 400 of FIG. 4. Wherein there are two speaker members 182 spaced from one another and located within interior volume 136 of main body 110 and adjacent said at least one side wall 124 of semi-circular portion 122, such that each speaker member 180 is adapted to be adjacent respective ears of person 410 using improved pillow 100. Wherein main body 110 further includes USB port 200 attached thereon and electrically connected to at least one speaker member 180 and adapted to allow electronic signals to be transferred therethrough. Wherein two speaker members 182 include BLUETOOTH technology 210 adapted to allow said two speaker members 182 to receive electronic signals wirelessly.

Wherein power source 190 is electrically connected to fan member 170 and at least one speaker member 180 and adapted to provide electric power thereto. Wherein power source 190 is formed as battery member 192. Wherein main body 110 further includes on/off switch 220 attached thereon and electrically connected between power source 190 and fan member 170 and at least one speaker member 180, and adapted to turn power on and off to fan member 170 and at least one speaker member 180.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. An improved pillow comprising:
a main body including:
a top surface;
wherein said top surface includes a semi-circular portion in a center section thereof having at least one side wall and a head supporting wall forming a semi-circular indentation therein; and
wherein said semi-circular indentation is sized and adapted to have a person's head fit therein;
wherein said at least one side wall includes a first opening therethrough;
at least one side surface;
wherein said at least one side surface includes a second opening therethrough;
a bottom surface;
wherein said top surface, said at least one side surface, and said bottom surface form an exterior surface and an interior volume; and
a foam material;
wherein said foam material is located within said interior volume and is adapted to provide support to said top surface, said at least one side surface, and said bottom surface, and thereby adapted to support a person's head upon said semi-circular indentation;
a fan member;
wherein said fan member is located within said interior volume of said main body and adapted to draw air into said interior volume through said first opening and push air outwardly from said interior volume through said second opening;
at least one speaker member;
wherein said at least one speaker member is located within said interior volume of said main body and adjacent said at least one side wall of said semi-circular portion and adapted to send audio sounds into said semi-circular indentation, such that a person can hear said audio sounds when using said improved pillow; and
a power source;
wherein said power source is electrically connected to said fan member and said at least one speaker member and adapted to provide electric power thereto.

2. The improved pillow of claim 1, wherein there are two speaker members spaced from one another and located within said interior volume of said main body and adjacent said at least one side wall of said semi-circular portion, such that each speaker member is adapted to be adjacent respective ears of a person using said improved pillow.

3. The improved pillow of claim 3, wherein said two speaker members include BLUETOOTH technology adapted to allow said two speaker members to receive electronic signals wirelessly.

4. The improved pillow of claim 1, wherein said foam material is formed from memory foam material.

5. The improved pillow of claim 1, further comprising cooling gel located within said interior volume of said main body and adjacent said at least one side wall and said head supporting wall of said semi-circular portion of said top surface of said main body.

6. The improved pillow of claim 1, further comprising a pillow cover adapted to surround the main body.

7. The improved pillow of claim 6, wherein said pillow cover includes a semi-circular portion in a center section thereof including at least one side portion and a head supporting portion adapted to form a semi-circular indentation substantially similar to said semi-circular portion of said top portion of said main body; and wherein said pillow cover is adapted to contact a substantial portion of the exterior surface of said main body.

8. The improved pillow of claim 1, wherein said main body further includes a zipper member thereon adapted to allow access therethrough and into said interior volume.

9. The improved pillow of claim 1, wherein said power source is formed as a battery member.

10. The improved pillow of claim 1, wherein said main body further includes an on/off switch attached thereon and electrically connected between said power source and said fan member and said at least one speaker member, and adapted to turn power on and off to said fan member and said at least one speaker member.

11. The improved pillow of claim 1, wherein said main body further includes an USB port attached thereon and electrically connected to said at least one speaker member and adapted to allow electronic signals to be transferred therethrough.

12. The improved pillow of claim 7, wherein said pillow cover further includes an adjustment cord adapted to allow said pillow cover to be tightened and loosened around said exterior surface of said main body.

13. The improved pillow of claim 7, wherein said pillow cover is formed from a material chosen from a list of materials consisting of cotton, nylon, and silk.

14. The improved pillow of claim 12, wherein said adjustment cord is formed as a draw-string.
